(19) United States
(12) Patent Application Publication
(10) Pub. No.: US 2022/0287161 A1
(43) Pub. Date: Sep. 8, 2022

(54) COATINGS FOR ELECTRODES IN ELECTRIC ARC FURNACES

(71) Applicant: Ecolab USA Inc., St. Paul, MN (US)

(72) Inventor: Suresh R. Sriram, Aurora, IL (US)

(21) Appl. No.: 17/686,810

(22) Filed: Mar. 4, 2022

Related U.S. Application Data
(60) Provisional application No. 63/157,431, filed on Mar. 5, 2021.

(51) Int. Cl. H05B 7/085; C23C 4/02; C23C 4/06

(52) U.S. Cl. CPC H05B 7/085; C23C 4/02; C23C 4/06

(57) ABSTRACT

Described are graphite-containing electrodes comprising zirconium-based coatings, which slow the loss of material from the electrodes when used at high temperatures, for example when used in arc furnaces between 1000 and 2000° C. The zirconium-based coating may be disposed on a graphite-containing surface of the electrode, or on a pre-coating disposed on a surface of the electrode. The zirconium-based coatings include one or more zirconium compounds such as zirconia. Also described are compositions and methods to coat graphite-containing electrodes with zirconium-based coating compositions.

### FIELD OF APPLICATION

The application is directed at protective coatings for electrodes, more particularly to zirconium-containing coatings provided on graphite-containing electrodes.

### BACKGROUND

Carbon-based (e.g. graphite) electrodes used in furnaces (e.g. electric arc furnaces) for steel production are subjected to severe operating conditions including high temperature, the spallation of molten steel or other metals, and the passage of large electrical currents and charges through the electrodes. Illustrative electrodes used for these purposes vary in diameter from 15-30 inches (38-76 cm) and may even be two feet (0.61 meters) or more. Such electrodes may have lengths even as long as ten feet (3 meters) or more.

When these electrodes are used in electric arc furnaces, they are ultimately consumed or otherwise degraded because of oxidation and/or high temperatures. Industrial electric arc furnace temperatures can reach as high as 1,800° C. or even higher. While spraying arc furnace electrodes with water is often used to cool the electrodes during operation, and such cooling can somewhat mitigate degradation, nevertheless up to 70 percent by weight of the electrode may be oxidized and/or otherwise degraded. As electrode costs are a substantial part of the electric arc steel-making process, such losses are costly.

It would be highly desirable to provide electrodes that have a longer service life and are better protected from degradation and loss at the severe temperatures and other environmental conditions, such as those experienced by graphite-containing electrodes operating in electric arc furnaces.

### SUMMARY

Described herein are zirconium-based compositions and methods for coating and protecting graphite-containing electrodes such as those used in electric arc furnaces, protected graphite-containing electrodes that include zirconium-based coatings, and arc furnaces incorporating such protected electrodes.

Applicants have discovered that zirconium-based coating compositions can be applied to graphite-containing electrodes to increase the service life thereof. When cured (e.g. dried in some embodiments), the coating compositions form protective coatings on the electrodes. Applicants have discovered that protected graphite-containing electrodes thus coated exhibit a slower rate of loss of mass under conditions such as those experienced by electrodes in operating electric arc furnaces than similar electrodes absent the coating. Furthermore, such coated (protected) electrodes exhibit higher rate of cooling when cooled by water spray than similar electrodes absent the zirconium-based coatings. Accordingly, applying the zirconium-based coating compositions to graphite-containing electrodes in accordance with disclosed methods is expected to provide a longer service life for the electrodes. When used in electric arc furnaces, the protected electrodes last longer and thereby lower operating costs of arc furnaces incorporating them.

In one aspect is a method of protecting graphite electrodes, the method comprising applying a zirconium-based coating composition onto a graphite electrode, and curing the coating composition to form a protective coating on the graphite electrode.

In a further aspect is a protected graphite-containing electrode comprising a graphite-containing electrode and a zirconium-based coating disposed on a surface of the graphite-containing electrode. In some such embodiments, the protected, graphite-containing electrode may further include a pre-coating disposed on a surface of the underlying graphite-containing electrode to increase adhesion of the overlying zirconium-based coating to the graphite-containing electrode. Accordingly, in such embodiments, the pre-coating is disposed between the electrode (also referred to herein as “member”) and the zirconium-based coating. In practical effect, the pre-coating serves as a primer layer between the electrode and the zirconium-based coating. In other embodiments, the graphite-containing electrode does not include a pre-coating, and the zirconium-based coating may be disposed directly on a surface of the graphite-containing member (electrode).

In a further aspect is an arc furnace comprising at least one protected graphite-containing electrode, wherein the at least one protected graphite-containing electrode comprises a graphite-containing electrode and at least one zirconium-based coating provided on the electrode.

The disclosed compositions and methods mitigate degradation and consumption of the electrodes while improving the heat transfer and enhancing the cooling rate of the electrodes.

### BRIEF DESCRIPTION OF DRAWINGS

FIG. 1 is a schematic drawing of an arc furnace according to particular embodiments of the invention.

FIG. 2 is a schematic drawing of a protected electrode according to particular embodiments of the invention.

FIG. 3 is a schematic drawing of a protected electrode according to particular embodiments of the invention.

FIG. 4 is a graphical representation showing the coating benefit over thermal cycles at 1000° C.

FIG. 5 is a graphical representation showing results with no phytic acid pre-coating.

FIG. 6 is a graphical representation showing the coating benefits over thermal cycles at 1500° C.

FIG. 7 is a graphical representation showing the coating benefits over thermal cycles at 1100° C., 1300° C. and 1500° C.

FIG. 8 is graphical representation showing heat flux of the coated graphite electrodes.

### DETAILED DESCRIPTION

Although the present disclosure provides references to various embodiments, persons skilled in the art will recognize that changes may be made in form and detail without departing from the spirit and scope of the application. Various embodiments will be described in detail with reference to the figures. Reference to various embodiments does not limit the scope of the claims attached hereto. Additionally, any examples set forth in this application are illustrative and are not intended to be limiting and merely set forth some of the many possible embodiments for the appended claims.

Unless otherwise defined, all technical and scientific terms used herein have the same meaning as commonly understood by one of ordinary skill in the art. In case of conflict, the present document, including definitions, will control. Methods and materials are described below, although methods and materials similar or equivalent to those described herein can be used in practice or testing of the present application. All publications, patent applications, patents and other references mentioned herein are incorporated by reference in their respective entireties and for all purposes.

As used herein, the terms “comprise(s),” “include(s),” “having,” “has,” “can,” “contain(s),” and variants thereof are intended to be open-ended transitional phrases, terms, or words that do not preclude the possibility of additional acts or structures. The singular forms “a,” “and” and “the” include plural references unless the context clearly dictates otherwise. The present disclosure also contemplates other embodiments “comprising,” “consisting of” and “consisting essentially of,” the embodiments or elements presented herein, whether explicitly set forth or not.

As used herein, the term “optional” or “optionally” means that the subsequently described event or circumstance may but need not occur, and that the description includes instances where the event or circumstance occurs and instances in which it does not.

As used herein, the term “about” modifying, for example, the quantity of an ingredient in a composition, concentration, volume, process temperature, process time, yield, flow rate, pressure, and like values, and ranges thereof, employed in describing the embodiments of the disclosure, refers to variation in the numerical quantity that can occur, for example, through typical measuring and handling procedures used for making compounds, compositions, concentrates or use formulations; through inadvertent error in these procedures; through differences in the manufacture, source, or purity of starting materials or ingredients used to carry out the methods, and like proximate considerations. The term “about” also encompasses amounts that differ due to aging of a formulation with a particular initial concentration or mixture, and amounts that differ due to mixing or processing a formulation with a particular initial concentration or mixture. Where modified by the term “about” the claims appended hereto include equivalents to these quantities. Further, where “about” is employed to describe a range of values, for example “about 1 to 5” the recitation means “1 to 5” and “about 1 to about 5” and “1 to about 5” and “about 1 to 5” unless specifically limited by context.

As used herein, the term “substantially” means “to a large degree”.

As used herein, the term “substantially free of” a material means “to a large degree free of” that material or free of to an extent that the amount of the material present affects the properties of the composition by a negligible amount. For example, a composition substantially free of a specified compound or material may be free of that compound or material, or may have a minor amount of that compound or material present, such as through unintended contamination, side reactions, or incomplete purification. A “minor amount” may be a trace, an unmeasurable amount, an amount that does not interfere with a value or property, or some other amount as provided in context. A composition that has “substantially only” a provided list of components may consist of only those components, or have a trace amount of some other component present, or have one or more additional components that do not materially affect the properties of the composition. Additionally, “substantially” modifying, for example, the type or quantity of an ingredient in a composition, a property, a measurable quantity, a method, a value, or a range employed in describing the embodiments of the disclosure, refers to a variation that does not affect the overall recited composition, property, quantity, method, value, or range thereof in a manner that negates an intended composition, property, quantity, method, value, or range. Where modified by the term “substantially” the claims appended hereto include equivalents according to this definition.

As used herein, “consisting essentially of” and “consisting of” are construed as in U.S. patent law.

As used herein, any recited ranges of values contemplate all values within the range and are to be construed as support for claims reciting any sub-ranges having endpoints which are real number values within the recited range. By way of example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5; and fractions thereof e.g. 1.5-3.5, 1.7-4.8, etc.

Described is a protective coating system to protect electrodes against degradation, more particularly graphite-containing electrodes, and especially graphite-containing electrodes operated within electric arc furnaces. Described are protected electrodes suitable for use in the electric arc furnaces. Also described are arc furnaces including the protected electrodes. Further described are compositions and methods to coat electrodes in electric arc-type furnaces. In some embodiments the electric arc type furnaces are used in steel making. The disclosed coatings improve electrode life, improve the thermal flux and thereby enhance the cooling rate of the electrodes. Accordingly, one aspect of the invention is an arc furnace comprising one or more protected electrodes as described further herein.

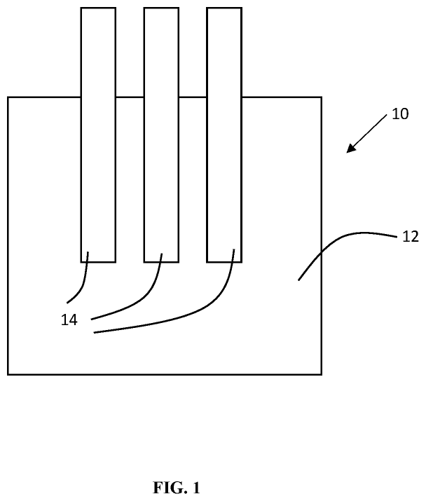

Protection strategies of the present invention can be practiced with a wide range of electrodes. For purposes of illustration, the principles of the present invention will be described in the context of an electric arc furnace. FIG. 1 illustrates an electric arc furnace (“EAF”) 10 that incorporates a plurality of protected electrodes 14 of the present invention. The walls of the furnace define an interior 12. In modes of practice in which electric arc furnace 10 is used for steelmaking, furnace 10 can be constructed of a refractory-lined vessel, usually water-cooled in larger sizes, and covered with a retractable roof.

In some embodiments, each of the electrodes 14 is clamped by an electrode holder or clamp for the electrode 14 to be inserted into the furnace 10. Electrodes 14 may enter the furnace through one or more openings such as openings through the roof. However, in other embodiments, one or more electrodes 14 may be inserted into furnace interior 12 through one or more walls or the floor of the furnace 10. In still other embodiments, the entirety of each electrode 14 may be disposed within interior 12.

The electrodes are automatically raised and lowered by a suitable positioning system, which may use either electric winch hoists or hydraulic cylinders. Furnace 10 desirably includes a regulating system. In some modes of practice, the regulating system helps to maintain approximately constant current and power input during the melting of the charge, even though scrap may move under the electrodes 14 as the charge melts.

Electric arc furnace 10 is a furnace that heats charged material by an electric arc. The electric arc is generated between the tip of the electrode 14 and the materials in the furnace to cause the materials to heat up and, if desired, melt. As the arc forms between the charged material and the electrode, the charge is heated both by current passing through the charge and by the radiant energy evolved by the arc. Embodiments of electric arc furnace 10 may be the electric arc furnaces that have been described in detail, for example by J. A. T. Jones, B. Bowman, P. A. Lefrank, “Electric Furnace Steelmaking”, in The Making, Shaping and Treating of Steel, R. J. Fruehan, Editor. 1998, The AISE Steel Foundation: Pittsburgh, but wherein such embodiments are modified to incorporate a protected electrode 14 of the present invention. The cited document is incorporated herein by reference in its entirety.

The graphite-containing electrodes 14 can operate in high temperature environments from 400° C. to 3000° C. In a conventional electric arc furnace, a typical electrode is oxidized and/or otherwise degraded, and is accordingly consumed in the high temperature atmosphere in the conventional furnace. As a result of such degradation, the shape of the electrode can be changed (e.g. into that of a pencil tip), and the diameter of the bottom of the electrode can be decreased to about 50-70% as compared with the original electrode diameter.

Degradation causes the electrode performance to suffer, requiring maintenance, service, or replacement of the degraded electrode. A significant advantage of the present invention is that the one or more protected electrodes 14 in furnace 10 are more resistant to degradation and thus are longer-lasting before needing maintenance, service, or replacement than a conventional unprotected electrode.

Electric arc furnace 10 may include one or more protected electrodes 14 of the present invention. For the purposes of illustration, arc furnace 10 is shown as powered by a three phase electrical supply and thus includes three protected electrodes 14. However, in other embodiments, the arc furnace comprises one, two, four, five, six, seven, eight, nine, ten, or more than ten electrodes and/or is supplied with other kinds of power such as a two phase power supply, or even a direct current power supply.

Each electrode 14 may comprise a single segment (part) or be assembled from multiple segments. An electrode 14 formed from multiple segments is referred to herein as a combination electrode. A combination electrode may be provided in segments that are assembled with threaded couplings. The threaded couplings allow the segments to be disassembled so that as the electrode segments wear, new segments can be added. In some embodiments, the combination electrodes have an upper metallic section to which a lower section comprising carbon materials such as graphite is attached by threaded couplings or threaded nipple or the like.

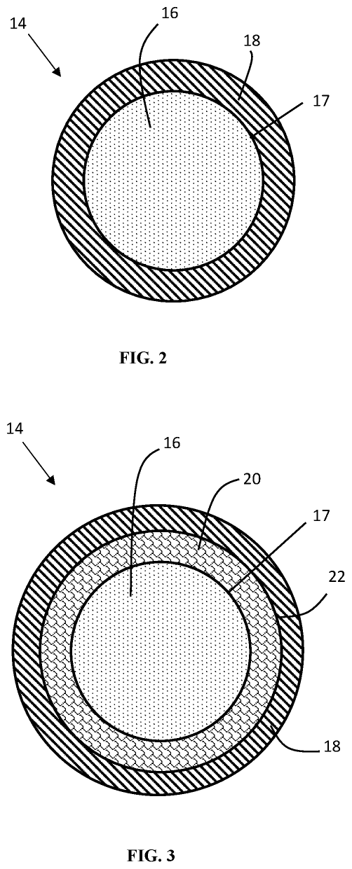

While the type of graphite-containing electrodes that may include and be protected by any of the zirconium-based coatings described herein is not particularly limited, for illustrative purposes, protected electrodes 14 are illustrated with particular reference to FIGS. 2-3, which depict electrodes 14 cylindrical in shape and, hence, circular in cross-section. However, alternative embodiments of electrodes 14 are described herein.

FIG. 2 shows an embodiment of a cylindrical protected electrode 14 in more detail and in cross-section. Protected electrode 14 includes graphite-containing member 16 having a surface 17. Protective zirconium-based coating 18 of the present invention is provided on at least a portion of surface 17. The graphite-containing member 16 may be a graphite-containing electrode or any part thereof, such as a graphite-containing segment of a combination electrode. Protective zirconium-based coating 18 is preferably present around the entire circumference of electrode 14, as shown in FIG. 2. However, partial coverage of surface 17 is also expected to have highly beneficial effects in slowing loss and/or degradation of member 16.

While FIGS. 2 to 3 show embodiments of a cylindrical protected electrode 14 for purposes of illustration, the shape and size of the graphite-containing electrode member 16 protected by the coatings of the invention are not particularly limited: in shape, the graphite-containing electrode may be cylindrical, cubic, cuboid, conical, frustoconical, polygonal cylindrical, irregular, and combinations thereof. For example, the electrode member 16 may be cylindrical in shape having a major axis but terminating in a tapered end, rounded end, a conical end narrowing to a tip, a frustoconical end tapering to a tip, and the like. For illustrative purposes, each of electrodes 14 is shown to have a blunt tip. However, as noted hereinabove, use of electrodes 14 in the furnace 10 results in degradation of electrodes 14 and a change in their shape. Accordingly, one or more tips of the electrodes 14 may be tapered or even other shapes before, during and/or after use.

The graphite-containing electrode member 16 may be any size. Electrode members 16 that are cylindrical have a length in the direction of the major axis and a circular cross-section in a plane perpendicular to the axis with a diameter. In particular embodiments, the diameter of electrode member 16 (or of the segments of the electrode in combination electrodes) is about one inch to 40 inches (0.0254 inches to 1.016 meters), about three inches to about 30 inches (0.0762 meters to 0.762 meters), or about seven inches to about 30 inches (0.1778 meters to 0.762 meters).

In illustrative embodiments, the length of the electrode member 16 is about one foot to 40 feet (0.3048 meters to 12.192 meters), about three feet to about 30 feet (0.9144 meters to 9.144 meters), about three feet to about 20 feet (0.9144 meters to 6.096 meters), about 10 feet to 30 feet (3 meters to 9.1 meters), about 10 feet to 20 feet (three meters to 6.1 meters), or about 12 feet to about 18 feet (3.7 meters to 5.5 meters). However, the electrodes may vary in length by loss of material from the electrode member 16, especially from the tip (that portion of the electrode proximal to the charge of the furnace to be melted); and in combination electrodes, the length may be varied or restored by the addition or replacement of segments of electrode member 16 such as to the end distal to the tip to compensate for the loss of electrode material from the tip proximal to the material to be melted within the furnace. The length of each segment may be about five feet to 15 feet (1.524 meters to 4.572 meters).

The graphite-containing electrode member 16 may comprise one or more of petroleum coke, needle coke, and graphite. The graphite-containing electrodes may further comprise coal pitch to bind the coke, which is an aggregate. Accordingly, in embodiments the electrode 16 comprises, consists of, or consists essentially of a one or more of petroleum coke, needle coke, and graphite; and coal pitch (coal tar). In some embodiments the electrodes 14 used in the electric arc-type furnaces are carbon based electrodes. In some embodiments the electrodes used in the electric arc-type furnaces are graphite-containing electrodes.

In particular embodiments of combination electrodes, a segment comprises, consists of, or consists essentially of graphite or a graphite-containing material; comprises a cylindrical or approximately cylindrical shape; and has an axis and a length along the axis.

Graphite-containing electrode member 16 may comprise 0 to 100 parts by weight of petroleum coke to zero to 100 parts by weight of needle coke, or other weight ratios of petroleum coke to needle coke may be used such as 90 parts to 10 parts, or 80 parts to 20 parts, or 70 parts to 30 parts, or 60 parts to 40 parts, or 50 parts to 50 parts, or 40 parts to 60 parts, or 30 parts to 70 parts, or 20 parts to 80 parts, or ten parts to 90 parts, or zero parts to 100 parts by weight of petroleum coke to needle coke. Low-sulfur petroleum coke is preferred to high-sulfur petroleum coke, where petroleum coke is present. A higher proportion of needle coke than petroleum coke is preferred for high-temperature applications. However, the disclosed protective coatings 18 are useful for a variety of electrode materials including a variety of graphite types.

Any of the protective coating compositions 18 disclosed herein may be applied to one or more surfaces of a graphite-containing electrode member 16 of any size or shape in order to provide resultant protected electrodes 14 protected by protective coatings 18.

FIG. 3 shows a further embodiment of the cylindrical protected electrode 14 in cross-section in which the protected electrode 14 of FIG. 2 is modified in FIG. 3 to further include a pre-coating 20 having surface 22. Protected graphite-containing electrode 14 comprises the graphite-containing electrode (graphite-containing member 16 and pre-coating 20) and zirconium-based coating 18. The pre-coating 20 is disposed on at least a portion of surface 17 of graphite member 16, and zirconium-based coating 18 is disposed on at least a portion of surface 22 of pre-coating 20. Preferably all or most of the outer circumferential surface of electrode 14 comprises zirconium-based coating 18 contiguous with pre-coating 20, as shown in FIG. 3. In other words, pre-coating 20 may be coat substantially all of the surface 17 of member 16, and protective coating 18 may coat the entire underlying surface 22 of pre-coat 20. However, partial coverage of surface 17 with pre-coating 20 and/or partial coverage of the pre-coating with protective coating 18 is expected to provide benefits in prolonging the life of member 16.

The pre-coating 20 promotes adhesion of the zirconium-based protective coating 18 to graphite-containing member 16. However, in embodiments that lack a separate pre-coating 20, such as the embodiment shown in FIG. 2, zirconium-based coating 18 may comprise one or more components of pre-coating 20 in order to promote adhesion of protective coating 18 to surface 17 without having to use a separate primer layer such as pre-coat 20. In embodiments, the one or more components that may be incorporated into pre-coat 20 and/or protective coating 18 comprise, consist of, or consist essentially of phytic acid (PA).

In some embodiments, the zirconium-based coating compositions 18 of FIGS. 2 and 3 act not only as thermal barrier coatings having low thermal conductivity but also serve to provide oxidation protection, improved heat flux or a combination thereof. In some embodiments, the zirconium-based coatings have a melting point of at least about 2000° F. (1093° C.), at least about 2200° F. (1204° C.), or in the range of from about 2200° to about 3500° F. (from about 1204° to about 1927° C.)

The coating compositions 18 of FIGS. 2 and 3 are useful for extending the life of the electrodes 14. In some embodiments, the coating composition 18 and, if used, the pre-coating 20 are applied as a thermal barrier coating for protecting graphite electrodes used in electric arc furnaces used in steel production.

Methods of Making Protected Electrodes

Any of the zirconium-based coating compositions and embodiments thereof described herein may be used in any of the methods of making protected electrodes 14 and embodiments thereof as described herein.

With reference to FIG. 2, a zirconium-based coating composition may be applied directly to at least surface 17 of a graphite-containing member 16. The graphite-containing member 16 is a graphite-containing electrode or a part thereof, such as a segment of a graphite-containing electrode. In some such embodiments, the zirconium-based coating composition is a liquid (that is normally a liquid at one atmosphere and 20° C. or is heated to a suitable temperature to be a liquid). The liquid may be a single phase or multiple phases such as if a liquid or solid phase is dispersed in a liquid phase carrier. The zirconium-based coating composition can be applied continuously or in batches and any number of times (with or without a curing process between applications).

In embodiments that comprise a pre-coating such as pre-coating 20 as illustrated in FIG. 3, a liquid pre-coating composition (i.e. a pre-coating composition that is a liquid at one atmosphere and 20° C. or is heated to a suitable temperature to be a liquid) is applied to surface 17 of the graphite-containing member 16, and optionally cured to form a pre-coating 20 on surface 17 to form a pre-coated unprotected electrode having surface 22. The zirconium-based coating composition is applied to a surface 22 of cured pre-coating 20 or to the uncured pre-coating composition. The pre-coating composition and the zirconium-based coating composition can be applied multiple times, with or without curing between any of the applications. The application or applications of the pre-coating composition and the zirconium-based coating composition can be performed in any sequence, optionally with the proviso that with respect to the embodiment of FIG. 3 at least one application of the pre-coating composition precedes the first application of the zirconium-based coating composition or is carried out simultaneously therewith. This proviso is desirable in those instances in which the electrode member 16 has not previously been treated with a protective coating of the present invention. In other modes of practice, a previously protected electrode member 16 can have its protection refreshed or renewed by reapplying one or more further pre-coat(s) 20 and/or one or more further protective coatings 18. In some modes of practice a plurality of pre-coats 20 are applied after which one or more protective coatings 18 are applied. In some modes of practice, alternating coatings of the pre-coat 20 and protective coating 18 are applied until two or more of each type of coating are provided on member 16. The pre-coating composition and the zirconium-based coating composition are cured on a surface of the electrode member 16.

Any of the zirconium-based coating compositions and/or pre-coating compositions described herein may be applied and cured on a graphite-containing electrode 14, a part thereof, or a graphite-containing member 16 before the electrode, part, or member is installed into an arc furnace 10; or, in the alternative, the coating compositions may be applied to the electrode 14, part, or member 16 after the installation of the electrode 14, part, or member 16 as part of the furnace assembly. In the latter case, one or both types of coating composition may be applied to the electrode 14, part thereof, or member 16 during operation of the furnace 10.

Graphite-containing electrodes used in arc furnaces often comprise cylindrical or substantially cylindrical, segments fixed so that the electrode is shaped like an elongated cylinder. It is often the case that each graphite-containing electrode is mounted in a substantially vertical direction so that it is supported by a clamp and projects downward from the clamp into the arc furnace, whereby a portion of the electrode is disposed outside the arc furnace between the clamp and the top of the furnace, and a portion of the electrode passes through an opening in the top of the arc furnace and protrudes downward into the interior of the arc furnace. The lower end of the electrode—that terminating portion closest to the bottom of the arc furnace—is particularly subject to loss, such that over time the terminating portion becomes tapered, namely narrower than the substantially cylindrical portion further from the bottom of the furnace, and eventually graphite is lost from the lower end of the electrode whereby the electrode becomes shorter. To compensate for the shortening of the electrode, new substantially cylindrical portions of graphite are affixed to the top of the electrode (that terminating portion of the electrode furthest from the arc furnace) and the tip of the electrode is lowered. This practice may be used with protected electrodes 14 of the present invention. In that way, a graphite-containing electrode is maintained despite a process of loss of graphite from the lower end of the electrode.

Graphite-containing electrodes 14 of FIGS. 1-3 may be cooled by water sprayed from nozzles arranged about the major axis of the electrode. In other words, the nozzles are deployed circumferentially around the electrode 14 and spray cooling water radially inward toward the electrodes 14. The graphite-containing electrode 14 may be cooled by spraying water onto the perimeter of the electrode, for example onto the curved surface of the graphite-containing electrode 14 where the curved surface is disposed between the clamp and the arc furnace 10. Accordingly, many conventional arc furnaces already include a means of applying a liquid such as water to a major surface of the electrode between the clamp and the top of the arc furnace and above the furnace itself. The cooling water evaporates, thereby cooling the electrode.

Such application strategies may be used in the practice of the present invention not only to supply cooling liquid but also to apply coatings of the present invention to the electrodes 14 while those electrodes are installed in the furnace 10. Advantageously, the zirconium-based coating compositions described herein may be liquids that can be sprayed in addition to or instead of water using existing sprayer installations associated with arc furnaces. While the zirconium-base coating composition may be sprayed onto the graphite-containing electrode member 16 outside the arc furnace interior cavity, the liquid composition may run down the electrode under the influence of gravity, thereby coating at least a portion of the major surface of the electrode. Even if none of the liquid composition reaches the lower end of the electrode before all of the water content of the composition has evaporated, the coated graphite-containing electrode comprises a coated layer of the zirconium-based coating over a portion of the major surface of the electrode, preferably around the circumference of the electrode. As the lower portion of the electrode proximal to the charge of the furnace is continuously lost, the electrode is lowered, new segments are added at the top, coating is added to the portion of the electrode as it is located proximal to the sprayer, and eventually the lower end of the electrode comprises the zirconium-based coating, which slows the rate of graphite loss as described herein.

Accordingly, in some embodiments the zirconium-based coating composition is applied to the graphite-containing electrode member 16 or the pre-coated graphite-containing electrode member 16 by spraying the zirconium-based coating composition onto the graphite-containing electrode member 16 in situ, namely while the graphite-containing electrode member 16 is disposed or partially disposed within an arc furnace 10. In some such embodiments, the zirconium-based coating composition may be sprayed onto a surface of the graphite-containing electrode member 16 located between a clamp and the top of the arc furnace. Part or all of the zirconium-based coating composition may adhere to the graphite-containing electrode member 16 (or a pre-coated portion thereof), and possibly run down the graphite-containing electrode member 16 under the influence of gravity. The water content evaporates, leaving a zirconium-based coating on the surface of the graphite-containing electrode member 16 and/or the pre-coated surface of the graphite-containing electrode member 16, for example between the clamp and the top of the arc furnace 10, or even as far down as a portion of the graphite-containing electrode disposed within the arc furnace. The coating left on the graphite-containing electrode slows the loss of the graphite on which it is disposed.

Each of the coating compositions used to provide protective coating 18 or pre-coat 20 may be applied at a wet thickness of 0.1 to 5 microns thick, for example about 0.1 to about 5 microns, about 0.2 to about 4 microns, about 0.1 to about 3 microns, about 0.2 to about 2 microns, or about 1 micron.

In some embodiments, the coating compositions used to provide protective coating 18 or pre-coat 20 may be applied as an aqueous solution. In some embodiments, a coating composition is applied by any suitable method such brushing, painting, spraying, immersing or the like and any combinations thereof. The coating compositions used to provide protective coating 18 or pre-coat 20 may be applied any number of times as needed.

In some embodiments, spraying of the coating compositions used to provide protective coating 18 or pre-coat 20 is by spray rings. In some embodiments, the spray rings are reported in U.S. Pat. No. 4,852,120, which patent is incorporated herein by reference in its entirety. In some embodiments, the spray rings are located below the electrode clamp and the coating composition is sprayed below the electrode clamp. In some embodiments, the spray rings are used for local, in situ applications, during operation of the electrodes. In some embodiments, the configuration of the spray ring is as depicted in FIG. 3 of U.S. Pat. No. 4,852,120.

Curing is a physical or chemical process in which a material liquid becomes solid through a chemical change such as crosslinking, a physical action such cooling and solidifying, a physical action such as loss of a liquid solvent (e.g. by evaporation) from the material, physical crosslinking, or combinations thereof. In embodiments wherein the zirconium-based coating composition comprises a liquid carrier such as water, curing may comprise, consist of or consist essentially of allowing or causing the zirconium-based coating composition to dry by evaporation of the liquid carrier in the ambient conditions or with application of heat optionally under vacuum in air or an artificial atmosphere such as one comprising nitrogen carbon dioxide, argon, reduced oxygen content, and/or the like.

The coatings 18 and 20 may be applied to an electrode member 16 while it is installed or uninstalled in the furnace 10 (FIG. 1). For example, the coatings may be applied onto electrode member 16 while installed in the furnace 10. When the protected electrode 14 is in operation, the electrode 14 and environs are subject to heat from the arc between the electrode tip and the charge of the furnace 10, the heat may cause evaporation of any liquid carrier in the zirconium-based coating composition, thereby curing (drying) the composition to a zirconium-based coating and providing any curing necessary. However, the curing of the coating composition may also be assisted. Accordingly, in some such embodiments, the drying comprises, consists of, or consists essentially of passing a flow of gas over the wet-coated graphite-containing electrode, heating the coated graphite-containing electrode at a temperature between 30° C. and 2000° C., or a combination of the passing and the heating. In some such embodiments the gas is air or nitrogen. In embodiments, the drying comprises, consists of, or consists essentially of heating the wet-coated graphite-containing electrode at a temperature of about 60° C. to about 2000° C., in embodiments, 100° C. to 2000° C., in embodiments 150° C. to 1600° C., in embodiments about 150° C. to about 1600° C., in embodiments about 100° C. to about 1000° C., or in embodiments about 200° C. to about 1000° C.

The curing of the zirconium-based coating composition and/or the pre-coating may occur at the location of application of the coating composition on the electrode, or (if liquid), the coating composition may run down a surface of the electrode under the influence of gravity and cure (e.g. dry) in a different location from that where it was first applied.

In some embodiments, a pre-coating 20, also referred to as a bond coat 20 due to its ability to help the protective coating 18 bond to the member 16, is applied before the zirconium-based coating composition. The bond coat 20 helps to better adhere the protective coating 18 (e.g. zirconium-based coating). In some embodiments the bond coating or a pre-coating 20 is applied simultaneously with the coating composition used to form protective coating 18 or can be applied before the protective coating composition and optionally followed by simultaneously applying additional bond coat material with the protective coating composition. In some embodiments, the bond coating or pre-coating 20 comprises phytic acid (also referred to as inositol hexakisphosphate (IP6) or inositol polyphosphate). In some embodiments, the bond coating 20 is pre-applied at a phytic acid concentration of 40 ppm to 10,000 ppm in a liquid carrier such as water. In some embodiments when the coating compositions used to provide protective coating 18 or pre-coat 20 are applied simultaneously, the weight ratio of the pre-coat composition to the protective coating composition is from 1:1 or 2:1. In some embodiments when the coating compositions used to provide protective coating 18 or pre-coat 20 are applied simultaneously, the bond coating and the coating composition are each applied at a concentration ranging from 1.5 ppm to 1500 ppm by weight.

Zirconium-Based Coating Compositions

The embodiments of zirconium-based coating compositions may be used in any method and embodiment thereof disclosed herein for making protected graphite-containing electrodes 14.

In embodiments useful to make protected electrodes 14, the zirconium-based coating composition comprises, consists of, or consists essentially of one or more zirconium compounds and a carrier liquid such as water or other aqueous carrier. Optionally, the zirconium-based coating compositions may one or more yttrium compounds, phytic acid, and/or other ingredient(s). Preferably the carrier liquid is aqueous and comprises water and at least one other solvent. In some embodiments, the carrier liquid may comprise, consist of, or consist essentially of water.

In some embodiments, at least one of and in some embodiments each and every zirconium compound of the one or more zirconium compounds is a compound that thermally decomposes, hydrolyses, and/or otherwise reacts to form a zirconia at a temperature between 60° C. and 2,000° C., in some embodiments between 100° C. and 1500° C. in the presence of water (water vapor and/or steam) and/or in some embodiments between 100° C. and 1500° C. in the absence of water.

The one or more zirconium compounds may comprise, consist of, or consist essentially of one or more of zirconium oxychloride, zirconium (IV) acetylacetonate, and zirconia. In some embodiments, the one or more zirconium compounds in the zirconium-based coating composition may comprise, consist of, or consist essentially of one or more of zirconium oxychloride and zirconium (IV) acetylacetonate.

The one or more yttrium compounds are optional in the zirconium-based coating composition, and may comprise, consist of, or consist essentially of one or more of yttrium acetate, yttrium nitrate, yttrium sulfamate, yttrium lactate, yttrium formate, yttrium (III) chloride, yttrium sulfate, and any combination thereof. In some embodiments, if present, one or more yttrium compounds may comprise, consist of, or consist essentially of yttrium acetate, yttrium sulfamate, yttrium lactate, yttrium formate, and any combination thereof. Without being bound by theory, it is speculated that yttrium compounds assist in preventing mass loss from electrodes in operational conditions of arc furnaces. Further, however, without being bound by theory, it is speculated that yttrium nitrate, although beneficial with respect to helping to further prolong the life of an electrode, nonetheless may have oxidizing properties that reduce the life of the electrode compared with other yttrium compounds. It is further speculated that other nitrates including nitric acid also have oxidizing properties that reduce electrode life. Accordingly, yttrium nitrate compounds are not preferred yttrium compounds. Desirably, if one or more yttrium compounds are present, yttrium nitrate compounds are excluded.

The zirconium-based coating composition may comprises about 0.01 mg to about 10 mg of the one or more zirconium compounds per mL of zirconium-based coating composition, or about 0.5 mg/mL to about 10 mg/mL, or about 0.1 mg/mL to about 10 mg/mL, or about 0.1 mg/mL to about 5 mg/mL, or about 0.3 mg/mL to about 3 mg/mL, or about 1.0 mg/mL to about 2.0 mg/mL, or about 1.0 mg/mL to about 1.4 mg/mL, or about 1.2 mg/mL, or about 1.5 mg/mL, or about 0.1 mg/mL to about 0.8 mg/mL, or about 0.5 mg/mL to about 10 mg/mL, or about 0.5 mg/mL to about 0.8 mg/mL, or about 0.75 mg/mL.

The zirconium-based coating composition may comprise about 0 mg to about 0.5 mg of the one or more yttrium compounds per mL of the zirconium-based coating composition, or about 0 mg/mL to about 1.5 mg/mL, or about 0.1 mg/mL to about 0.7 mg/mL, or about 0.2 mg/mL to about 0.3 mg/mL, or about 0.3 mg/mL.

The zirconium-based coating composition may comprise the one or more zirconium compounds and the one or more yttrium compounds in a weight ratio of the one or more zirconium compounds to the one or more yttrium compounds of about 15:1 to about 1:1, or about 10:1 to about 5:1, or about 9:1 to about 6:1, or about 9:1 to about 7:1, or 8:1.

The zirconium-based coating composition may comprise about 0.01 mg to about 10 mg of phytic acid per mL of zirconium-based coating composition, or about 0.1 mg/mL to about 5 mg/mL, or about 0.3 mg/mL to about 3 mg/mL, or about 0.1 mg/mL to about 0.8 mg/mL, or about 0.5 mg/mL to about 10 mg/mL, or about 0.5 mg/mL to about 0.8 mg/mL, or about 0.75 mg/mL of the phytic acid.

In some embodiments wherein the zirconium-based coating composition comprises phytic acid, the weight ratio of one or more zirconium compounds to phytic acid is about 2:1 to 1:2, in some embodiments about 3:2 to 2:3, or in some embodiments about 1:1.

The zirconium-based coating may be applied to the graphite-containing electrode as an aqueous composition. The aqueous composition may be a solution, aqueous dispersion, aqueous slurry, or any combination thereof, viz. some or all of the materials in the zirconium-based coating may be dissolved and/or dispersed in water.

The zirconium-based coating composition may be about 99 to 75% zirconium (based on the combined weight of zirconia and the other additives in the coating composition), or from about 90 to about 80% zirconium. In one specific such embodiment, a zirconium-based coating composition comprises, consists of, or consists essentially of an aqueous solution of zirconium (IV) acetylacetonate in water at a concentration of 1.5 mg/mL weight for volume of solution. In a further specific embodiment, a zirconium-based coating composition comprises, consists of, or consists essentially of an aqueous solution of zirconyl chloride (zirconium oxychloride) at a concentration of 1.5 mg/mL weight for volume of solution.

Pre-Coating Compositions

The pre-coating composition may comprise, consist of, or consist essentially of phytic acid in a carrier liquid. In preferred such embodiments, the carrier liquid is a solvent, preferably comprising, consisting of, or consisting essentially of water. The phytic acid may be dissolved, dispersed, or both dissolved and dispersed in the carrier liquid. The carrier liquid may comprise, consist of, or consist essentially of water. The concentration of the phytic acid in the pre-coating composition may be about 1 mg to about 100 mg of phytic acid per mL of pre-coating composition, or about 5 mg/mL to about 80 mg/mL, or about 10 mg/mL to about 60 mg/mL, or about 20 mg/mL to about 60 mg/mL, or about 30 mg/mL to about 50 mg/mL, or about 40 mg of phytic acid per mL of pre-coating solution. The concentration of phytic acid in the pre-coating composition may be about 1 mg to about 100 mg of phytic acid per mL of solvent, or about 5 mg/mL to about 80 mg/mL, or about 10 mg/mL to about 60 mg/mL, or about 20 mg/mL to about 60 mg/mL, or about 30 mg/mL to about 50 mg/mL, or about 40 mg of phytic acid per mL of carrier liquid. In particular embodiments, the pre-coating may comprise one or more zirconium compounds and/or one or more yttrium compounds as described herein with regard to the zirconium-based coating compositions.

After curing (e.g. drying), any of the zirconium-based coating compositions disclosed herein becomes a zirconium-based coating 18 (FIGS. 2 and 3). After curing (e.g. drying), any of the pre-coating compositions become a pre-coating 20 (FIG. 3). The composition of the resulting coating in some modes of practice is expected to be similar or the same as the composition of the coating composition minus the liquid carrier that is lost during curing. However, without being limited by theory, it is believed at least a portion of the one or more zirconium compounds and/or the one or more yttrium compounds decompose under the conditions of high temperature experienced in an arc furnace, perhaps to form one or more zirconium oxide compounds and/or one or more yttrium oxide compounds, respectively. For example, zirconium acetylacetonate and/or zirconium oxychloride may decompose to a material comprising zirconium and oxide species. Accordingly, it is possible that the composition of the zirconium-based coatings changes with time and/or proximity to the tip of the electrode. However, regardless of whether any of the one or more zirconium and/or yttrium compounds decomposes, Applicant has discovered that after application of the zirconium-based coating compositions and drying thereof, the protected electrodes 14 have an extended life and reduced loss of mass.

In some embodiments, the zirconium-based coatings 18 comprise one or more chemically stabilized zirconias (viz., various metal oxides such as yttrium oxides blended with zirconia), such as yttria-stabilized zirconias, ceria-stabilized zirconias, calcia-stabilized zirconias, scandia-stabilized zirconias, magnesia-stabilized zirconias, india-stabilized zirconias, ytterbia-stabilized zirconias as well as mixtures of such stabilized zirconias. See, for example, Kirk-Othmer's Encyclopedia of Chemical Technology, 3rd Ed., Vol. 24, pp. 882-883 (1984) for a description of suitable zirconias.

In some embodiments, the zirconium-based coating 18 comprises, consists of, or consists essentially of a chemically stabilized zirconia, wherein the chemically stabilized zirconia comprises, consists of, or consists essentially of zirconia and a stabilizing metal oxide, wherein the stabilizing metal oxide is selected from the group consisting of yttria, calcium oxide, scandia, india, ytterbia, and any combination thereof.

In some embodiments, the chemically stabilized zirconias comprise, consist of, or consist essentially of zirconia, the stabilizing metal oxide, and one or more thermal conductivity adjustment metal compounds. In embodiments, the one or more thermal conductivity adjustment metal compounds comprises, consists of, or consists essentially of one or more lanthanide oxides, one or more actinide oxides, or a combination thereof. In embodiments, the one or more thermal conductivity adjustment metal compounds comprises, consists of, or consists essentially of a compound selected from the group consisting of dysprosia, erbia, europia, gadolinia, neodymia, praseodymia, urania, hafnia, one or more pyrochlores, and any combination thereof to further reduce thermal conductivity of the thermal barrier coating.

Each of the one or more pyrochlores has the general formula A₂B₂O₇ where A is a metal having a valence of 3+ or 2+ (e.g., gadolinium, aluminum, cerium, lanthanum or yttrium) and B is a metal having a valence of 4+ or 5+ (e.g., hafnium, titanium, cerium or zirconium) where the sum of the A and B valences is 7. In embodiments, A is selected from the group consisting of gadolinium, aluminum, cerium, lanthanum and yttrium. In embodiments, B is selected from the group consisting of hafnium, titanium, cerium and zirconium. In embodiments, the one or more pyrochlores are selected from the group consisting of gadolinium zirconate, lanthanum titanate, lanthanum zirconate, yttrium zirconate, lanthanum hafnate, cerium zirconate, aluminum cerate, cerium hafnate, aluminum hafnate, lanthanum cerate, and any combination thereof.

In some embodiments, the protected electrode 18 when subjected to high temperatures shows less oxidation and better heat flux as compared to a similar but unprotected electrode. In some embodiments the protected electrode weight loss is reduced by about 2% to 95%; 5% to 75%; 5% to 50%; 5% to 25%; 2% to 10%; 5% to 15%; 50% to 95%; 50% to 20%; or 50% to 75% when an unprotected electrode and a protected electrode are subject to identical degradation conditions.

After curing, the dry thickness of the zirconium-based coating may be 0.01 to 100 nm, or 0.05 to 10 nm, or 0.05 nm to 7 nm, or 0.1 to 5 nm.

Accordingly, there is provided a protected graphite-containing electrode 18 comprising, consisting of, or consisting essentially of a graphite-containing electrode member 16 and a zirconium-based coating 18 disposed on at least a portion of a surface 17 of the graphite-containing electrode member 16.

In another aspect is disclosed a coated graphite-containing electrode 18 comprising, consisting of, or consisting essentially of: a graphite-containing member 16 including a surface 17; a pre-coating 20 disposed on at least a portion of the surface 17 of the graphite-containing member 16, wherein the pre-coating 20 includes a surface 22; and a zirconium-based coating 18 disposed on at least a portion of the surface 22 of the pre-coating 20. The pre-coating 20 functions at least in part as a bond coating designed and adapted to promote adhesion of the zirconium-based coating 18 to the graphite-containing electrode member 16, wherein the bond coating is disposed between the graphite-containing member 16 and the zirconium-based coating 18.

The pre-coating 20 may comprise, consists of, or consist essentially of phytic acid.

The zirconium-based coating 18 may comprise, consists of, or consists essentially of zirconium oxychloride, zirconium acetylacetonate, zirconia, or any combination thereof.

The zirconium-based coating 18 may comprise, consists of, or consist essentially of one or more zirconium compounds.

The zirconium-based coating 18 may comprise, consist of, or consist essentially of one or zirconium compounds and one or more yttrium compounds.

The zirconium-based coating 18 may comprise, consist of, or consist essentially of one or more zirconium compounds, and phytic acid and/or a salt of phytic acid.

The zirconium-based coating 18 may comprise one or more zirconium compounds, one or more yttrium compounds, and phytic acid and/or a salt of phytic acid.

The one or more zirconium compounds may comprise, consist of, or consist essentially of one or more of zirconium oxychloride, zirconium (IV) acetylacetonate, and zirconia. The one or more yttrium compounds may comprise, consist of, or consist essentially of yttrium acetate, yttrium sulfamate, yttrium lactate, yttrium formate, yttria, yttrium (III) chloride, yttrium (III) sulfate.

The zirconium-based coating 18 may comprise the one or more zirconium compounds in an amount of about 10% to 100% by weight of the zirconium-based coating, or about 40 weight percent (wt %) to 100 wt %, or about 70 wt % to 100 wt %, or about 60 wt % to 100 wt %, or about 80 wt % to about 90 wt %, or about 80 wt % to 100 wt %, or about 30 wt % to about 60 wt %, or about 30 wt % to about 70 wt %, or about 40 wt % to about 60 wt %, or about 50 wt %, or about 40 wt %, or about 30 wt % to about 50 wt %, or about 20 wt % to about 60 wt %, or 100 wt %.

The zirconium-based coating may comprise the phytic acid in an amount of about 10 wt % to about 80 wt % based on the weight of the zirconium-based coating, or about 10 wt % to about 90 wt %, or about 20 wt % to about 70 wt %, or about 30 wt % to about 60 wt %, or about 40 wt % to about 60 wt %, or about 50 wt % based on the weight of the zirconium-based coating.

The zirconium-based coating 18 may comprise the one or more yttrium compounds in an amount of about 1 wt % to about 20 wt % of the one or more yttrium compounds, or about 2 wt % to about 20 wt %, or about 1 wt % to about 15 wt %, or about 2 wt % to about 12 wt %, or about 6 wt % to about 16 wt %, or about 8 wt % to about 11 wt %, or about 9 wt % to about 11 wt %, or about 8 wt % to about 10 wt %, or about 10 wt % of the one or more yttrium compounds based on the weight of the zirconium-based coating.

If the zirconium-based coating 18 comprises the one or more yttrium compounds, the weight ratio of the one or more zirconium compounds to the one or more yttrium compounds may be about 15:1 to about 1:1, or about 10:1 to about 5:1, or about 9:1 to about 6:1, or about 9:1 to about 7:1, or about 8:1.

In some embodiments wherein the zirconium-based coating 18 comprises phytic acid, the weight ratio of one or more zirconium compounds to phytic acid is about 2:1 to 1:2, in some embodiments about 3:2 to 2:3, or in some embodiments about 1:1.

### EXAMPLES

The following examples are intended to illustrate different aspects and embodiments of the invention and are not to be considered limiting the scope of the invention. It will be recognized that various modifications and changes may be made without departing from the scope of the claims.

### Example 1. Evaluation of Coatings

The various coatings were evaluated under electric arc like conditions. Graphite electrode materials were used to obtain circular graphite disks. The disks weighed approximately 22-26 grams with a diameter of 3.5 cm and thickness of about 1.5 cm. Before use, the disks were cleaned with deionized water, acetone, and isopropanol and then dried under nitrogen. The clean, dry graphite disks were immersed in a solution of phytic acid (PA) at a concentration of 40 mg/mL for 5 minutes, and after removal from the PA solution, the disks were then immersed in different solutions obtained by mixing an equal volume solution of phytic acid (1.5 mg/mL) and various sample additive solutions at 1.5 mg/mL for a period of 5 mins at room temperature. The various sample additives are shown in Table 1. After removing the disks from the various sample solutions, the coated graphite disks were dried under nitrogen and placed in an oven at 65° C. for about 30 minutes. The coated disks were weighed before being placed in a high temperature oven at 1000° C. for 1 hour. After the 1 hour period at the high temperature the graphite disks were cooled down to room temperature. The room temperature-cooled graphite disks were weighed to record the final weight of the graphite disk after the thermal treatment and the % weight remaining was recorded. Gravimetric analysis was carried out to measure the wt. % remaining based on the initial and final weight of the graphite disk. The various sample additives are shown in TABLE 1.

TABLE 1

| | | Initial | Final | % weight of |
|---|---|---|---|---|
| | | weight of | weight | electrode |
| Sample | Description | electrode (g) | of electrode | remaining |
| 8818-21A | Control | 22.07 | 10.01 | 45.4 |
| | (no coating) | | | |
| 8818-21B | FeCl₃ | 23.44 | 15.33 | 65.4 |
| 8818-21C | ZrOCl₂ | 23.36 | 14.64 | 62.7 |
| 8818-21D | Zr(acac)₄ | 23.53 | 16.56 | 70.4 |
| 8818-21E | ZrOCl₂ + | 24.03 | 15.69 | 65.3 |
| | Y(NO₃)₃ | | | |
| 8818-21F | Zr(acac)₄ + | 24.38 | 12.68 | 52.0 |
| | HNO₃ | | | |
| 8818-21G | Zr(acac)₄ + | 24.21 | 10.34 | 42.7 |
| | Y(NO₃)₃ + HNO₃ | | | |

ZrOCl₂ = Zirconium oxychloride (zirconyl chloride) CAS# 7699-43-6.
Zr(acac)₄ = Zirconium acetylacetonate CAS# 17501-44-9.
Phytic acid (inositol hexakisphosphate) CAS# 83-86-3.
FeCl₃ = Iron (III) chloride (ferric chloride) CAS# 7705-08-0.
Yttrium acetate (Y(OAc)₃•4H₂O) CAS# 85949-60-6.
Y(NO₃)₃ = Yttrium nitrate (Y(NO₃)₃•6H₂O) CAS# 13494-98-9.

The data in Table 1 was shown as the weight percent remaining for the coated graphite disks when compared to the control untreated graphite disk each subjected to a single thermal treatment at 1000° C. for 1 hour.

### Example 2. Coatings Evaluated Over Multiple Thermal Cycles

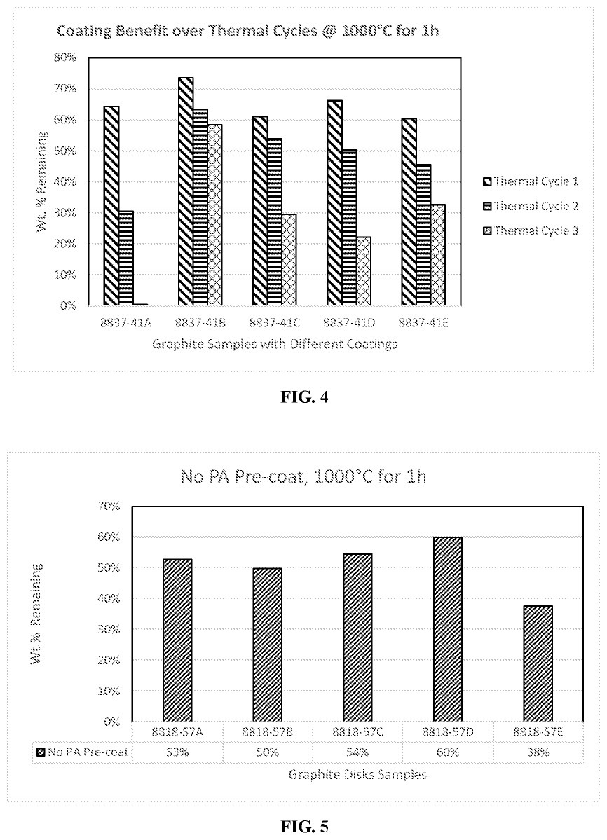

The graphite disks and the various treatments are as described in Example 1 and TABLE 2. The various treated disks were subject to three different thermal cycles. Each thermal cycle was at 1000° C. for 1 hour. After the disks were subjected to the first cycle at 1000° C. and the disks were cooled, and the same disk was subject to another round of heating at 1000° C. Following cooling of the disk, the same disk is subject to a third round of heating at 1000° C. The data is shown in FIG. 4 as the wt. % remaining for the coated graphite disks when compared to the control untreated graphite disk each subjected to multiple thermal treatments at 1000° C. for 1 hour. The control uncoated graphite is completely degraded with 0 wt. % remaining at the end of the third thermal cycle at 1000° C. for 1 hour.

TABLE 2

| Sample | Description |
|---|---|
| 8837-41A | Control (no coating) |
| 8837-41B | FeCl₃ |
| 8837-41C | ZrOCl₂ |
| 8837-41D | Zr(acac)₄ |
| 8837-41E | ZrOCl₂ + Y(NO₃)₃ |

### Example 3. Evaluation of Disk without Pre-Coating

The graphite disks and the various treatments are as described in Example 1 and TABLE 3. Unlike Example 1, however, the disks were not subject to a phytic acid pre-coat. The data is shown in FIG. 5 as the wt. % remaining for the coated graphite disks when compared to the control untreated graphite disk each subjected to thermal treatment at 1000° C. for 1 hour but without the phytic acid pre-coat step. The data shows that the control uncoated graphite disk is similar to the coated graphite disk samples without the initial pre-coat with phytic acid.

TABLE 3

| | | % weight of |
|---|---|---|
| Sample | Description | electrode remaining |
| 8818-57A | Control (no coating) | 53 |
| 8818-57B | FeCl₃ | 50 |
| 8818-57C | ZrOCl₂ | 54 |
| 8818-57D | Zr(acac)₄ | 60 |
| 8818-57E | ZrOCl₂ + Y(NO₃)₃ | 38 |

### Example 4. Evaluation of Disk at Higher Temperatures

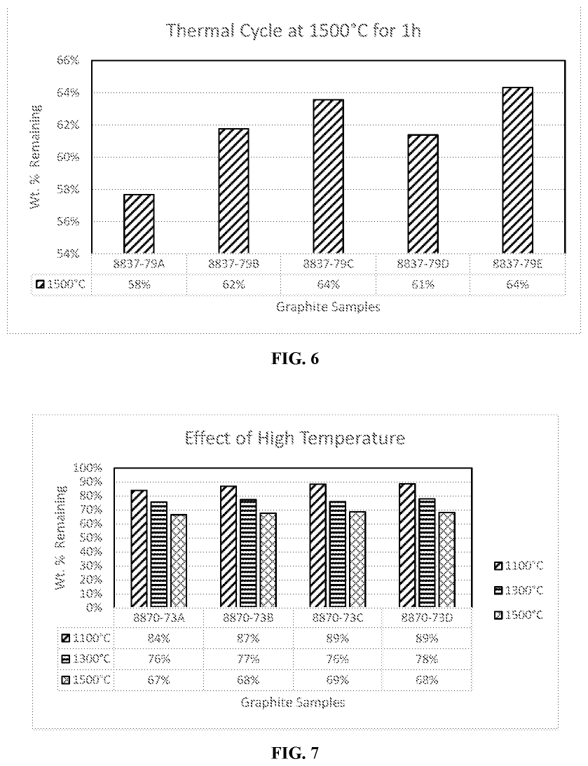

The graphite disks and the various treatments are as described in Example 1 and TABLE 4. Unlike Example 1, however, the disks were subjected to a temperature of 1500° C. for 1 hour. The data is shown in FIG. 6 as the wt. % remaining for the coated graphite disks when compared to the control untreated graphite disk each subjected to thermal treatment at 1500° C. for 1 hour. The results show that higher temperatures result in greater loss of the graphite disk. However, the coated graphite disk samples show a higher weight % remaining when compared to the untreated control.

TABLE 4

| | | % weight of |
|---|---|---|
| Sample | Description | electrode remaining |
| 8837-79A | Control (no coating) | 58 |
| 8837-79B | FeCl₃ | 62 |
| 8837-79C | ZrOCl₂ | 64 |
| 8837-79D | Zr(acac)₄ | 61 |
| 8837-79E | ZrOCl₂ + Y(NO₃)₃ | 64 |

### Example 5. Evaluation of Disk at Different Temperatures

The graphite disks and the various treatments are as described in Example 1 and TABLE 5. Unlike Example 1, however, the disks were subjected to temperatures of 1100° C., 1300° C. and 1500° C. for 1 hour. The data is shown in FIG. 7 as the wt. % remaining for the coated graphite disks when compared to the control untreated graphite disk subjected to different thermal treatments. The data shows that coated disks have a higher weight % remaining when compared to the untreated control. However, the coated disks showed reduced protection with increasing temperature.

TABLE 5

| | | % weight of electrode remaining | | |
|---|---|---|---|---|
| Sample | Description | 1100° C. | 1300° C. | 1500° C. |
| 8870-73A | Control (no coating) | 84 | 76 | 67 |
| 8870-73B | FeCl₃ | 87 | 77 | 68 |
| 8870-73C | ZrOCl₂ | 89 | 76 | 69 |
| 8870-73D | Zr(acac)₄ | 89 | 78 | 68 |

### Example 6. Evaluation of Heat Flux

Graphite electrodes were machined into the shape of a cylinder with a height of 2 inches, and a diameter of 1 inch in dimension. A small cavity was machined at the top of the cylinder in the center with the dimension of 0.033 inches in diameter and a height of 0.5 inches. Another cavity was machined at the bottom of the cylinder with the dimensions of 0.25 inches in diameter and 0.75 inches in height. The cavity was made to locate thermocouples to monitor the temperature of the electrode during heating and cooling.

The graphite cylinder was coated in the same manner as the graphite disks described Example 1 and TABLE 6.

TABLE 6

| Sample | Description | Heat flux |
|---|---|---|
| 8837-37A | Control (no coating) | 25000 |
| 8837-37B | FeCl₃ | 35000 |
| 8837-37C | ZrOCl₂ | 40000 |
| 8837-37D | Zr(acac)₄ | 40000 |

The graphite cylinder specimens were heated to 900° F. (482.2° C.) in a heating chamber with a gold-plated copper core and held in place with the help of an electromagnet. Once the graphite cylinder specimen reached 900° F., the graphite specimen was dropped between sprayers spraying water at ambient conditions on the graphite cylinder and the drop in temperature of the graphite specimen was monitored using thermocouple lodged on the top and bottom of the specimens. The data was recorded in a computer in real-time allowing plotting of the cooling curves of the graphite cylinder specimens. Using the cooling curves the heat flux data was calculated.

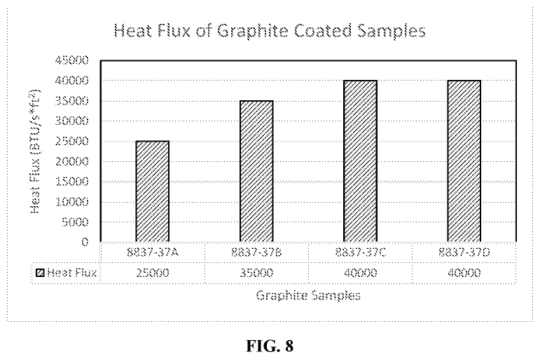

Higher heat flux for the coated graphite disks indicated better ability of the coated graphite samples to cool down when compared to the uncoated control. High heat flux is a measure of the improved heat transferability of the coated graphite samples. The data is shown in FIG. 8.

What is claimed is:

1. A method of protecting an arc furnace electrode, the method comprising:
applying a zirconium-based coating composition onto a surface of at least part of a graphite-containing electrode, the zirconium-based coating composition comprising one or more zirconium compounds and a liquid carrier; and
curing the zirconium-based coating composition to form a zirconium-based coating on the surface.

2. A method of protecting an arc furnace electrode, the method comprising:
applying a zirconium-based coating composition onto a surface of at least a part of a graphite-containing electrode, the zirconium-based coating composition comprising one or more zirconium compounds and water; and
drying the zirconium-based coating composition to form a zirconium-based coating on the surface.

3. The method of claim 2, wherein the graphite-containing electrode is at least partially disposed in an electric arc furnace during the applying.

4. The method of claim 2, wherein at least a portion of the applying occurs during operation of the electric arc furnace.

5. The method of claim 2, wherein the graphite-containing electrode comprises a curved surface, and wherein the applying comprises spraying the zirconium-based coating composition onto at least a portion of the curved surface.

6. The method of claim 2, the method further comprising inserting at least a portion of the electrode into an arc furnace after the applying.

7. The method of claim 2, wherein the zirconium-based coating composition comprises one or more of zirconium oxychloride, zirconium acetylacetonate, and zirconia.

8. The method of claim 2, wherein the one or more zirconium compounds in the coating composition is zirconium acetylacetonate.

9. The method of claim 2, wherein the zirconium-based coating composition further comprises one or more yttrium compounds.

10. The method of claim 2, wherein a concentration of the one or more zirconium compounds in the zirconium-based coating composition is about 0.1 mg/mL to about 10 mg/mL.

11. The method of claim 2, wherein the surface comprises phytic acid.

12. The method of claim 2, wherein the zirconium-based coating composition further comprises phytic acid.

13. A protected graphite-containing electrode comprising a graphite-containing electrode including a surface, and a zirconium-based coating disposed on at least a portion of the surface, wherein the zirconium-based coating comprises one or more zirconium compounds.

14. The protected graphite-containing electrode of claim 13, wherein the graphite-containing electrode comprises a combination electrode.

15. The protected graphite-containing electrode of claim 13, wherein the zirconium-based coating comprises one or more of zirconium oxychloride, zirconium acetylacetonate, and zirconia.

16. The protected graphite-containing electrode of claim 13, wherein the zirconium-based coating comprises zirconia.

17. The protected graphite-containing electrode of claim 13, wherein the zirconium-based coating further comprises one or more yttrium compounds.

18. The protected graphite-containing electrode of claim 13, wherein the zirconium-based coating comprises about 40 wt % to 100 wt % of the one or more zirconium compounds.

19. The protected graphite-containing electrode of claim 13, wherein the graphite-containing electrode includes a pre-coating comprising phytic acid, and wherein at least a portion of the zirconium-based coating is disposed on at least a portion of the pre-coating.

20. An arc furnace comprising the protected graphite-containing electrode of claim 13.
